(19) United States
(12) Patent Application Publication
(10) Pub. No.: US 2009/0100640 A1
(43) Pub. Date: Apr. 23, 2009

(54) Hinge Assembly

(76) Inventor: Jr-Jiun Chern, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/874,254

(22) Filed: Oct. 18, 2007

(51) Int. Cl. E05F 1/08

(52) U.S. Cl. 16/277; 16/379

(57) ABSTRACT

A hinge assembly for use with a notebook computer includes hinge a pintle, a pivoting device, and a friction-providing device. The pivoting device is pivotally installed on the pintle and includes a first supporting member, a second supporting member and a sleeve. The first supporting member includes a connecting portion and a pivotal portion into which the pintle inserts. The second supporting member is mounted to the first supporting member and includes a pivotal arm parallel to the pivotal portion. The sleeve is disposed between the pivotal portion and the pivotal arm and the pintle is receivable in the sleeve. The friction-providing device is disposed in the sleeve and intermediate between the pintle and the sleeve.

### BACKGROUND OF THE INVENTION

1. Field of the Invention

The present invention relates to a hinge assembly for use with a notebook computer or the like.

2. Description of the Related Art

Referring to U.S. Pat. No. 7,222,396, a hinge assembly comprises a pivot pin 10, a rotating leaf 20, a stationary leaf 30, and a spacer assembly 40. The spacer assembly 40 includes a L-shaped positioning element 43 which has a tab 431 adapted to insert into the stationary leaf 30. More specifically, the stationary leaf 30 has a hole 32 into which an end portion of the tab 431 insert into. The spacer assembly 40 further includes a biasing member 44 and a plurality of washers 45, in which the biasing member 44 is urged to provide a friction force between the rotating and stationary leafs 20, 30. Unfortunately, the biasing member 44 is not intended to provide a large friction force. Thus, if a notebook has a display which is heavy, it is difficult to retain the display in a desired position. Furthermore, if increasing the number of biasing members 44 for providing a larger friction, the hinge assembly would otherwise become increased in size.

Additionally, since the rotating and stationary leafs 20, 30 are both undergoing a torque force respectively, large torque force can cause the rotating and stationary leafs 20, 30 to distort, especially at the positioning element 43 and between the rotating leaf 20 and the pivot pin 10.

The present invention is, therefore, intended to obviate or at least alleviate the problems encountered in the prior art.

### SUMMARY OF THE INVENTION

Accordingly, the objective of the present invention is to provide a hinge assembly which overcomes the disadvantages of the prior art.

The hinge assembly for use with a notebook computer includes hinge a pintle, a pivoting device, and a friction—providing device. The pivoting device is pivotally installed on the pintle and includes a first supporting member, a second supporting member and a sleeve. The first supporting member includes a connecting portion and a pivotal portion into which the pintle inserts. The second supporting member is mounted to the first supporting member and includes a pivotal arm parallel to the pivotal portion. The sleeve is disposed between the pivotal portion and the pivotal arm and the pintle is receivable in the sleeve. The friction-providing device is disposed in the sleeve and intermediate between the pintle and the sleeve.

Other objectives, advantages, and novel features of the invention will become more apparent from the following detailed description when taken in conjunction with the accompanying drawings.

### BRIEF DESCRIPTION OF THE DRAWINGS

FIG. 1 is a perspective view of a hinge assembly in accordance with a first embodiment of the present invention.

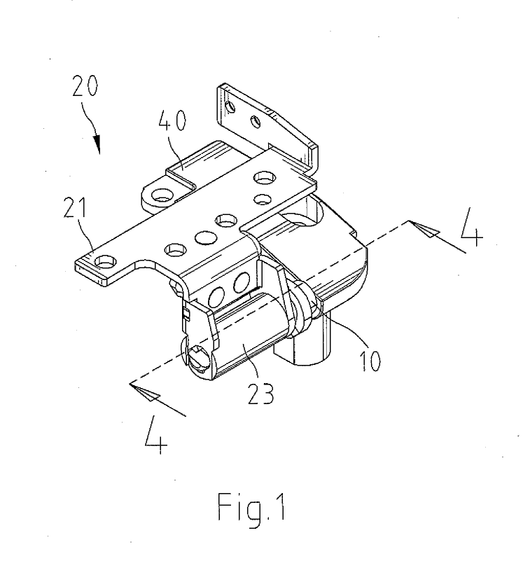

FIG. 2 is an exploded view of the hinge assembly.

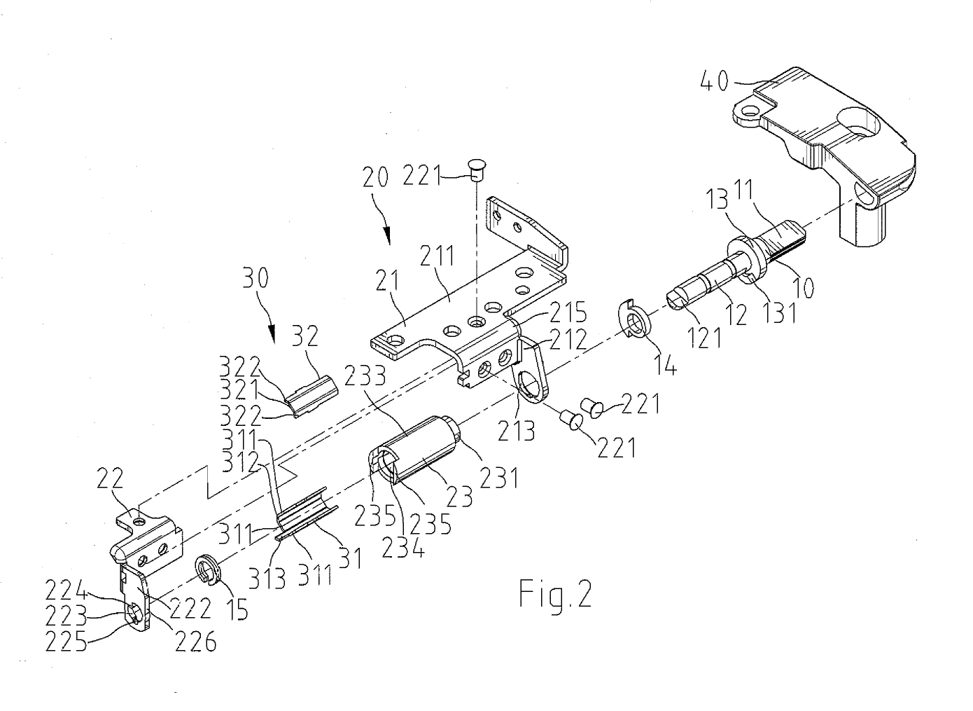

FIG. 3 is also an exploded view of the hinge assembly.

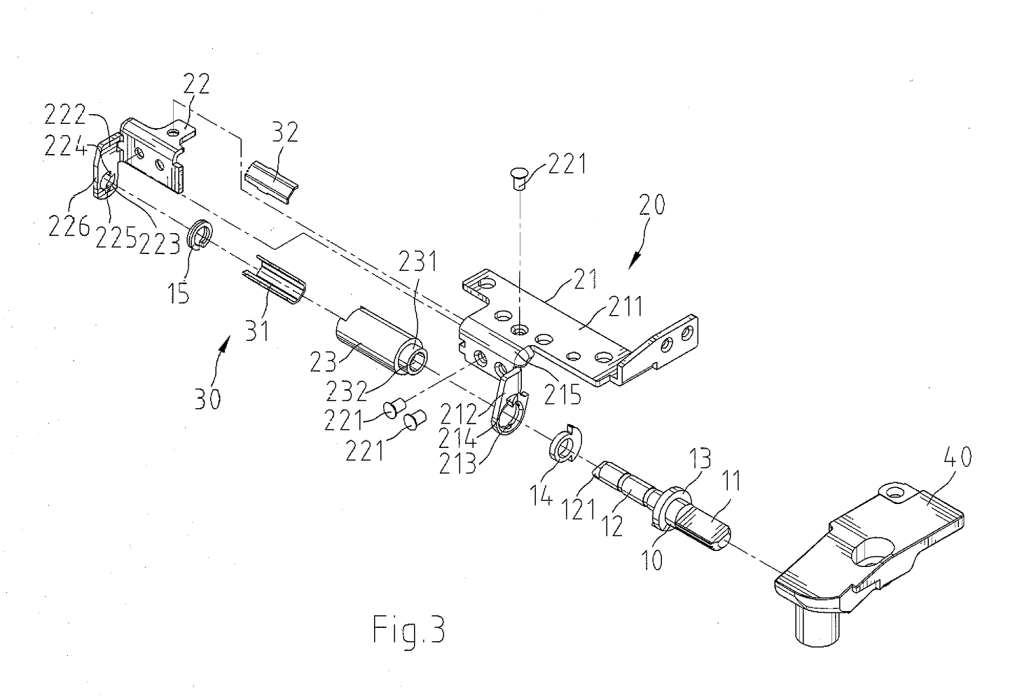

FIG. 4 is a cross-sectional view taken along line 4-4 of FIG. 1.

FIG. 5 is a cross-sectional view taken along line 5-5 of FIG. 4.

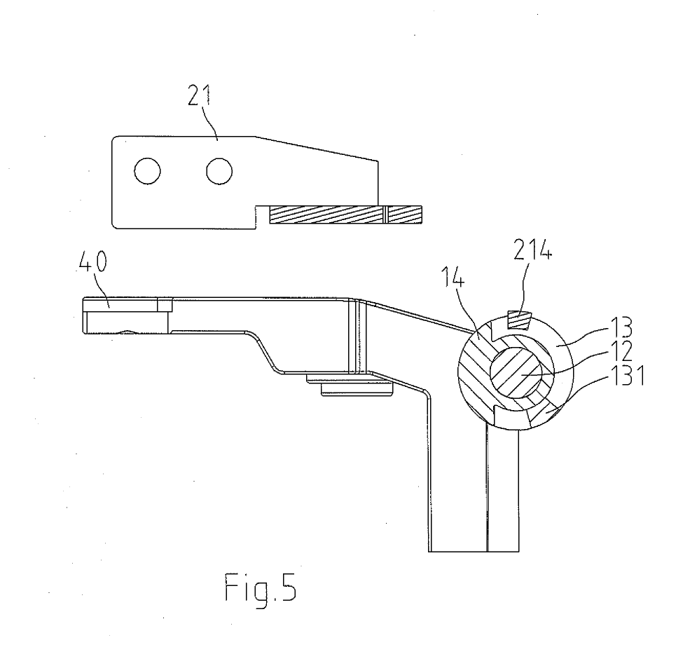

FIG. 6 is a cross-sectional view taken along line 6-6 of FIG. 5.

FIG. 7 is an exploded view of a hinge assembly in accordance with a second embodiment of the present invention.

### DETAILED DESCRIPTION OF THE PREFERRED EMBODIMENT

Referring to the drawings, a hinge assembly for use with a notebook computer comprises a pintle 10, a pivoting device 20, a friction-providing device 30, and a coupling member 40.

The pintle 10 includes a first portion 11 for pivotally engaging with the coupling member 40, a second portion 12 for pivotally engaging with the pivoting device 20, and a third portion 13 therebetween positioned against the pivoting device 20. The first portion 11 has an external peripheral wall, in which the peripheral wall is non-circular in cross section and has a portion having a series of paralleled grooves. The second portion 12 has a circular cross section, but has a section 121 which is non-circular. The third portion 13 has a side from which the second portion 12 extends, in which the side has a protrusion 131 formed thereon.

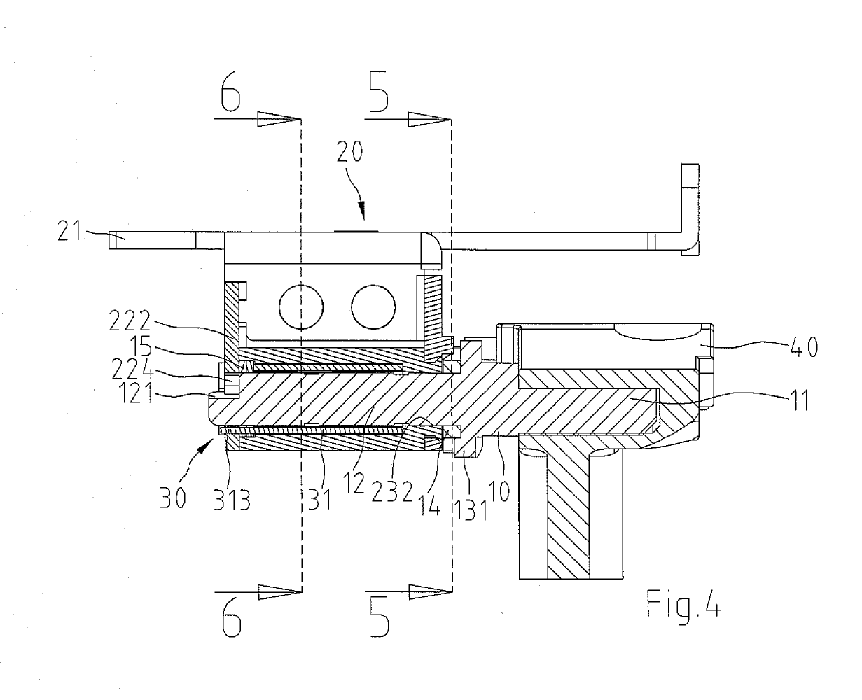

The pivoting device 20 is comprised of a first supporting member 21, a second supporting member 22, and a sleeve 23. The first supporting member 21 has a connecting portion 211 to which a display connect. A bend 215 extends perpendicularly from the connecting portion 211. A pivotal portion 212 extends perpendicularly from the bend 215. A hole 213 formed on the pivotal portion 212 into which the pintle 10 insert. A projection 214 which is selectively positionable against a protrusion 131 formed on the third portion 11 of the pintle 10 for stopping further rotation of the first supporting member 21 with respect to the pintle 10. A wear-resisting member 14 is mounted between the third portion 13 and the pivotal portion 212. Further, as best seen from FIG. 4, the rotation of the first supporting member 21 with respect to the pintle 10 can also be stopped if the projection 214 selectively positionable against the wear-resisting member 14.

The second supporting member 22 includes a L-shaped portion (not numbered) and a pivotal arm 222 perpendicular thereto. The pivotal arm 222 has an orifice 223 into which the pintle 10 is adapted to insert. The pivotal arm 222 further has a ridge 224 which is selectively positionable against the section 121 of the second portion 12 of the pintle 10 received in the orifice 223 for stopping further rotation of the second supporting member 22 with respect to the pintle 10. The pivotal arm 222 also has a recess 225 exposed to and in communication with the orifice 223. In addition, fasteners 221 are used to connect the first supporting member 21 to the second supporting member 22.

The sleeve 23 is installed between the pivotal portions 212, the pivotal arm 222 of the first and second supporting members 21,22. The sleeve 23 includes a first end 231 having a wall extending circumferentially and a cavity 232 formed therein. The sleeve 23 further has a second end 233 having a wall extending circumferentially and a slot 234 formed therein. The slot 234 is exposed to the cavity 232 and in communication therebetween. In addition, the second end 233 of the sleeve 23 has two lugs 235 spaced in a paralleled relationship and extending longitudinally therefrom. The lugs 235 are engagable with the pivotal arm 222 of the second supporting member 22. More specifically, the lugs 235 are engagable with paralleled side peripheral wall 226 respectively. Accordingly, the second supporting member 22 and the sleeve 23 are pivoted in concert with the pintle 10. Further, the pintle 10 is receivable in the cavity 232 and the slot 234.

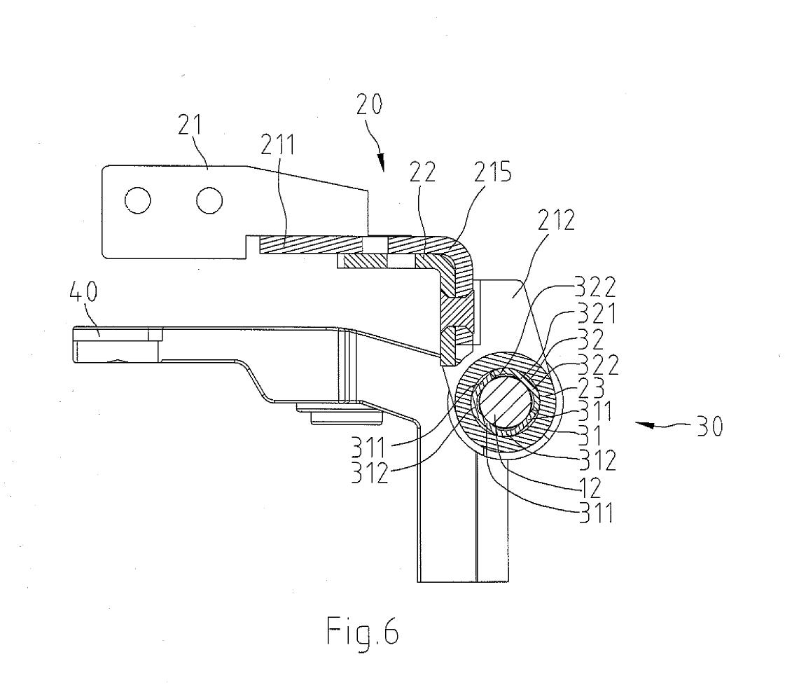

The friction-providing device 30 is comprised of a first and a second resilient member 31, 32 receivable in the sleeve 23. The first resilient member 31 is substantially U-shaped and has three flat portions 311 interconnected by two arcuate portions 312. Further, one of the arcuate portions 312 has an extension 313 receivable in the recess 225. The second resilient member 32 is substantially C-shaped and has a flat strip 321 and two arcuate strips 322, with the flat strip 321 intermediate the arcuate strips 322. In addition, the friction device 30 is receivable in the sleeve 23, and the pintle 10 is receivable in the friction-providing device 30. Thus, the friction-providing device 30 is disposed intermediate the pintle 10 and the sleeve 23. Further, as best seen in FIG. 6, the flat portions 311 and the arcuate portions 312 of the first resilient member 31 are located against the pintle 10 and the sleeve 23 respectively. In addition, a stabilizing member 15 is mounted between the friction-providing device 30 and the pivotal arm 222 of the second supporting member 22. The stabilizing member 15 is substantially C-shaped.

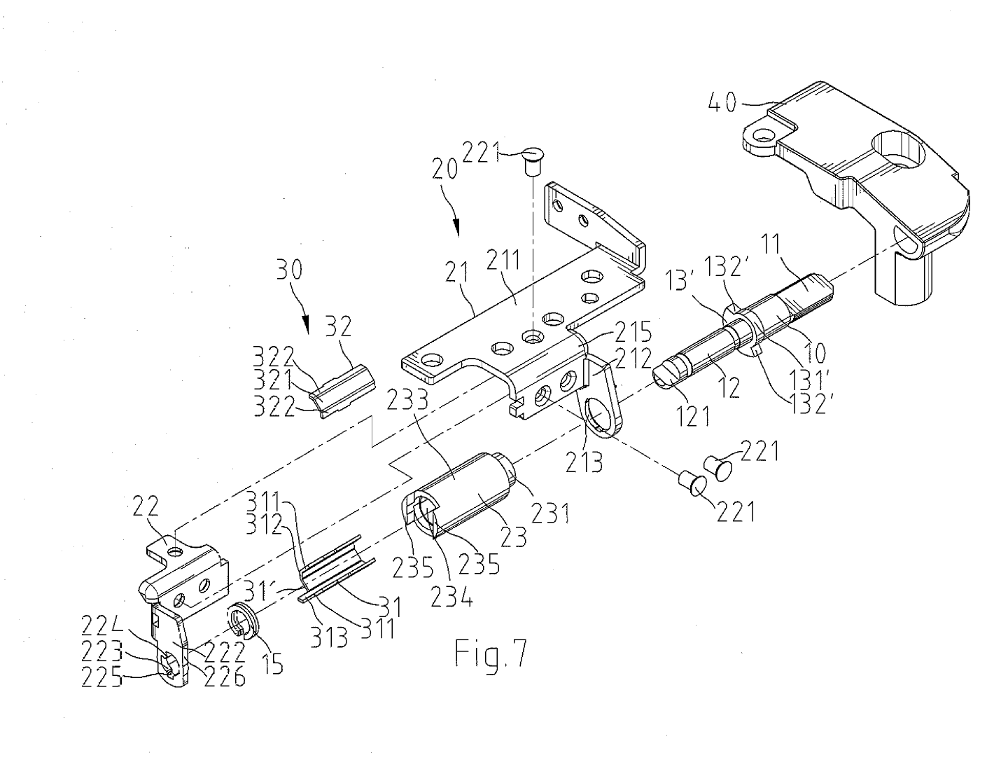

FIG. 7 shows another hinge assembly embodying the present invention, wherein like numerals are employed to like components of the prior embodiment, and like numerals bearing a suffix are employed to different components. The pintle 10 includes a third portion 13′ having a smaller diametrical section 131′ and a larger diametrical section 132′. As such, when the projection 214 of the pivotal portion 212 of the first supporting member 21 locates against one of two transition areas between smaller and larger diametrical sections 131′, 132′ of the pintle 10, rotation of the first supporting member 21 with respect to the pintle 10 is stopped. Furthermore, the wear-resisting member 14 is omitted.

What is claimed is:

1. A hinge assembly for use with a notebook computer comprising:
a pintle;
a pivoting device pivotally installed on the pintle, the pivoting device including a first supporting member, a second supporting member and a sleeve, with the first supporting member including a connecting portion and a pivotal portion into which the pintle is adapted to insert, with the second supporting member mounted to the first supporting member and including a pivotal arm parallel to the pivotal portion, with the sleeve disposed between the pivotal portion and the pivotal arm, and with the pintle receivable in the sleeve; and
a friction-providing device disposed in the sleeve and intermediate between the pintle and the sleeve.

2. The hinge assembly as claimed in claim 1 wherein the pintle comprises a section, and wherein the pivotal arm of the second supporting member has a ridge which is selectively positionable against the section of the pintle for stopping further rotation of the second supporting member with respect to the pintle.

3. The hinge assembly as claimed in claim 1 wherein the sleeve comprises a first end received in the pivotal portion of the first supporting member, and a second end engagable with the pivotal arm of the second supporting member, and wherein the second end has two lugs extending therefrom, and wherein the pivotal arm has two spaced side peripheral wall with which the lugs engage respectively.

4. The hinge assembly as claimed in claim 1 wherein the friction-providing device comprises a first and a second resilient member, with the first resilient member having three flat portions and two arcuate portions interconnected therebetween, with the second resilient member having a flat strip and two arcuate strips separated by the fiat strip, and wherein the flat portions and the arcuate portions of the first resilient member are located against the pintle and the sleeve respectively.

5. The hinge assembly as claimed in claim 1 wherein the first resilient member is U shaped, with two of the flat portions in paralleled relationship.

6. The hinge assembly as claimed in claim 5 wherein the pivotal arm comprises an orifice into which the pintle insert and a recess exposed to and in communication with the orifice, and wherein one of the arcuate portions of the first resilient member comprises an extension receivable in the recess, allowing the friction-providing device to be fixed with the second supporting member.

7. The hinge assembly as claimed in claim 1 wherein the pivotal portion of the first supporting member comprises a projection, and wherein the pintle comprises a first, a second and a third portion, with the third portion intermediate the first and second portions, and wherein the third portion comprises a protrusion which is selectively positionable the projection for stopping further rotation of the first supporting member with respect to the pintle.

8. The hinge assembly as claimed in claim 7 wherein the third portion comprises a smaller diametrical section and a larger diametrical section, and wherein the projection of the first supporting member is selectively positionable against one of two transition areas between smaller and larger diametrical sections of the pintle.
